(19) United States
(12) Patent Application Publication
(10) Pub. No.: US 2021/0206417 A1
(43) Pub. Date: Jul. 8, 2021

(54) CHILD CARRIER AND DOCKING ASSEMBLY

(71) Applicant: PÅHOJ AB, MALMO (SE)

(72) Inventor: Lycke VON SCHANTZ, MALMO (SE)

(21) Appl. No.: 17/055,989

(22) PCT Filed: May 15, 2019
(86) PCT No.: PCT/SE2019/050436

§ 371 Date: Nov. 16, 2020

(30) Foreign Application Priority Data
May 21, 2018 (SE) 1850593-3
Jul. 6, 2018 (SE) 1850854-9

(51) Int. Cl. B62B 7/12; B62K 27/12

(52) U.S. Cl. CPC B62B 7/126; B62B 2206/006; B62K 27/12

(57) ABSTRACT

The present invention describes a child carrier and docking assembly adapted to be removably mounted to a bicycle, moped, electric bike or the like, said assembly comprising a child carrier unit which is in the form of a hybrid child seat and stroller possible to connect to a docking unit of the assembly, said docking unit comprising two units, one first unit being an adapter arranged to be fixated to the bicycle, moped, electric bike or the like, and one second unit 2 arranged to be fixated to or integrated into the child carrier unit, wherein the second unit 2 is lockable into and releasable from the first unit 1 so that the child carrier unit is locked to and released from the bicycle, respectively.

### FIELD OF THE INVENTION

The present invention relates to a child carrier and docking assembly in the form of a hybrid child seat and stroller possible to connect to a docking unit of the assembly, e.g. suitable for a bike.

### TECHNICAL BACKGROUND

Systems comprising a combined child carrier and docking assembly adapted to be removably mounted to a bicycle has been disclosed before. In WO 2016/003359 there is disclosed a child carrier assembly adapted to be removably mounted to a bicycle, said carrier assembly comprising a seat, a backrest portion, a footrest portion, two side portions, means for seating a child and means for supporting a child while seated, a docking assembly for connecting said child carrier assembly to said bicycle, where said child carrier assembly is adapted to function as a convertible stroller by means of comprising a wheel assembly and a handle bar, where said docking assembly comprises one part being fixed to said bicycle and one part being fixed to said child carrier assembly, where said connection parts being releaseably mountable to one another, wherein said docking assembly comprises a spring loaded mechanism and wherein said spring loaded mechanism controls said releasable docking assembly by means of comprising one movable part and one fixed part, where the docking assembly has a locking function so that an upper docking assembly unit fixed to said carrier assembly is dockable and undockable to a lower docking assembly unit fixed to said bicycle, and wherein the upper docking assembly unit comprises two separate unlocking handles.

One purpose of the present invention is to provide an improved child carrier and docking assembly which is very effective to lock and release from e.g. a bike, and thus is connected to the bike in a safe way.

### SUMMARY OF THE INVENTION

The above purpose is provided by a child carrier and docking assembly adapted to be removably mounted to a bicycle, moped, electric bike or the like, said assembly comprising a child carrier unit which is in the form of a hybrid child seat and stroller possible to connect to a docking unit of the assembly, said docking unit comprising two units, one first unit being an adapter arranged to be fixated to the bicycle, moped, electric bike or the like, and one second unit arranged to be fixated to or integrated into the child carrier unit, wherein the second unit 2 is lockable into and releasable from the first unit 1 so that the child carrier unit is locked to and released from the bicycle, respectively, wherein the first unit 1 comprises a handle 3 which is arranged to be pulled out when the child carrier unit is intended to be released from the bicycle, moped, electric bike or the like, said handle 3 having two end positions, one first end position where the handle 3 is in a locked state and where an interconnecting unit 6 of the first unit 1 is in connection to, fixating and locking the second unit 2, and one second end position in an open state where the handle 3 is in a fully extended position and where the interconnecting unit 6 is released from the second unit 2. The present invention provides a solution where the stroller is securely locked to e.g. a bicycle when they are connected to each other, i.e. when the second unit is connected to the first unit. Moreover, the stroller is also simple to lock to and unlock (release) from the bicycle.

To give further reference to prior art it may be mentioned that in JP2004268670A there is disclosed a docking assembly adapted to be removably mounted to a bicycle. The focus in this document is on locking of a basket. It is mentioned that a chair for small children is one possible alternative, however this is not the same thing as a stroller. The present invention differs from JP2004268670A both in terms of the connecting (locking and releasing) arrangement and also that the present invention is directed to a child carrier unit in the form of a hybrid child seat and stroller, which is not the case in JP2004268670A.

In this regard it may be said the expression “hybrid child seat and stroller” according to the present invention implies a unit which may function both as a child seat when being connected to a bicycle or such as well as a child stroller when it is released from the bicycle.

### Specific Embodiments of the Present Invention

Below specific embodiments of the present invention are disclosed.

According to one embodiment of the present invention, the interconnecting unit is spring-loaded.

According to yet another embodiment, the handle is spring-loaded so that the handle is self-locking when the handle is not pulled out by force.

Furthermore, according to another specific embodiment, when the handle is in a locked state then the interconnecting unit is extended downwards and passes a portion of the second unit to fixate the second unit and lock the hybrid child seat and stroller and second unit to the first unit.

Moreover, according to yet another embodiment, the interconnecting unit is extended downwards and acts as a plug into the second unit to fixate the second unit and lock the hybrid child seat and stroller and second unit to the first unit when the handle is in a locked state.

Furthermore, according to one specific embodiment, when the handle is pulled out then the interconnecting unit is pushed upwards to be released from the portion of the second unit to release the second unit from the first unit.

According to yet another embodiment of the present invention, the second unit arranged to be fixated to or integrated into the child carrier unit is arranged to be pulled onto and grip around the first unit being an adapter arranged to be fixated to the bicycle, moped, electric bike or the like when fixating the second unit to the first unit.

Moreover, the child carrier and hence second unit is suitably arranged to be lifted outwards horizontally to be released completely from the first unit when the handle is in a fully extended position and hence open state.

Furthermore, according to yet another specific embodiment of the present invention, the interconnecting unit is angled.

Moreover, as mentioned above an open/locked indicator is suitably connected to the first unit.

According to yet another embodiment of the present invention, a handle security lock is arranged to enable security locking and unlocking of the handle. The handle security lock may be a bar arranged to be pushed, pulled or moved to unlock the handle.

Furthermore, it may also be mentioned that in the case of a stroller being the child carrier unit, then this stroller may suitably be collapsible/foldable. Moreover, the stroller may be in many different shapes and designs. Examples are a stroller with only single wheels in four positions, but also double wheels may be provided in the rear of the stroller. The present invention, however, is not limited to any such stroller designs.

Furthermore, it should be noted that the present invention is directed to a child carrier unit which suitably is in the form of seat and stroller, but also other applications are possible according to the present invention. For instance, a child carrier unit may be directed to basket or loading applications, i.e. as a storage unit or loading unit, where a first unit and a second unit are arranged and connected such as described according to the present invention.

### DESCRIPTION OF THE DRAWINGS

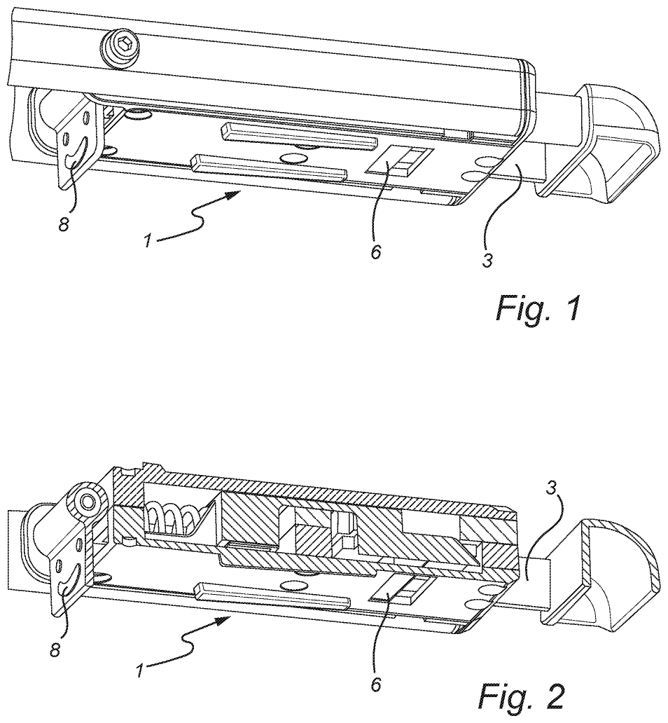

In FIGS. 1-10 specific embodiments of the present invention are shown. In these examples the hybrid child seat and stroller is adapted for a regular type of a bike, however also other applications are totally possible according to the present invention, such as a moped or electric bike.

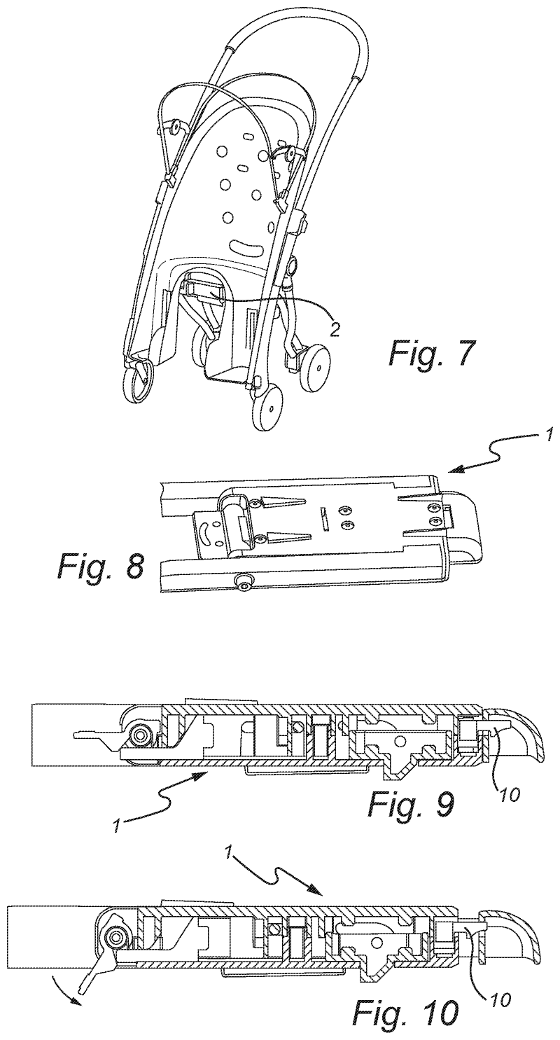

In FIG. 1 there is shown one embodiment according to the present invention. In this case there is shown the handle 3 (trigger) totally pulled out so that the handle 3 is in an open state. The lock button/interconnecting unit 6 in this situation is pulled inwards, so the system is disengaged, and where the interconnecting unit 6 is released from the second unit 2. Therefore, a hybrid child seat and stroller (see FIGS. 6 and 7) can be pulled off from the docking unit being the first unit 1. Moreover, there is also shown an open/locked indicator 8 which is connected to the first unit 1.

In FIG. 2 there is shown the same situation as in FIG. 1, however in a section. The guiding surface of the trigger/handle 3 on the lock is shown now.

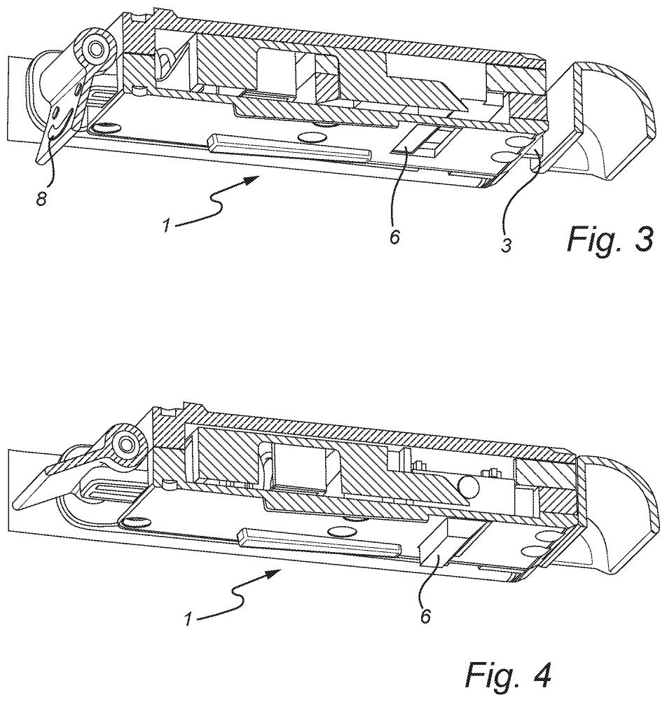

In FIG. 3 there is shown a sequence when a locking of the unit is about to be made. When the pulling trigger/handle 3 is released, the springs will make the trigger/handle 3 move inside the box. The end of the trigger/handle 3 will now start pushing the smiley flag/open/locked indicator 8. (circled area)

In FIG. 4 a further part of a sequence is shown. When the pulling trigger/handle 3 is totally inside the box, the lock of the interconnecting unit 6 is totally pushed out of the box. The end of the trigger/handle 6 is now pushing up the smiley flag/open/locked indicator 8. Therefore, only if the trigger/handle 3 is inside the box, the locking hook can be out and lock the system.

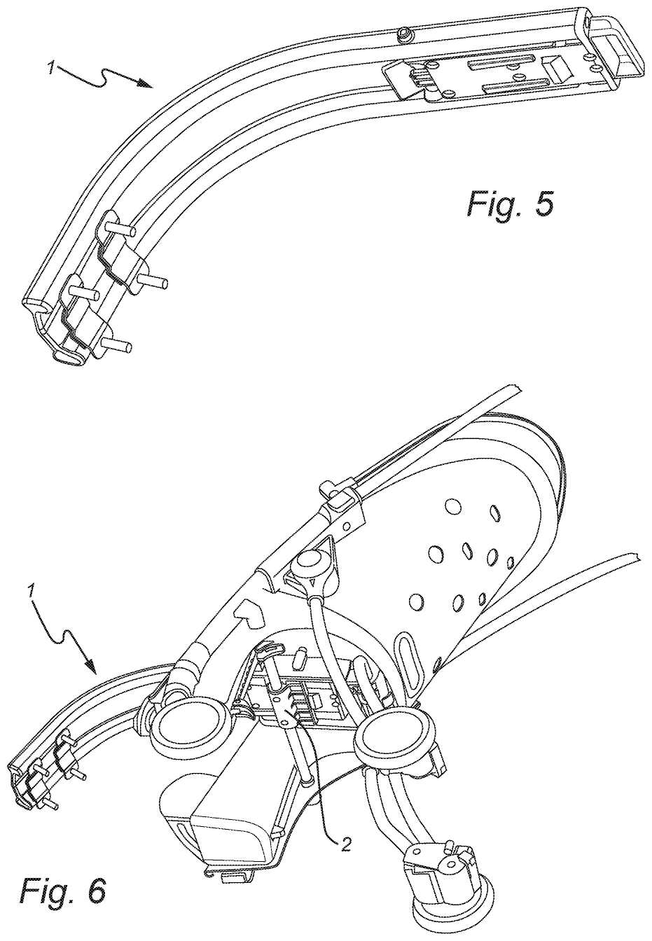

In FIG. 5 there is shown one embodiment of a first unit 1 according to the present invention.

In FIG. 6 there is shown how a second unit 2 and thus the hybrid child seat and stroller is fixated and locked to a first unit 1 according to one embodiment of the present invention.

In FIG. 7 there is shown hybrid child seat and stroller with a connected second unit 2 when the hybrid child seat and stroller is standing on the ground.

In FIGS. 8-10 there is a first unit 1 according to one embodiment of the present invention. In this case a handle security lock 10 is arranged to enable security locking and unlocking of the handle 3. The security lock 10 is a bar arranged to be pushed, pulled or moved to unlock the handle 3. This type of security lock 10 may be provided to increase the safety for locking and unlocking and may be needed according to certain requirements, e.g. EN14344.

1. A child carrier and docking assembly adapted to be removably mounted to a bicycle, moped, electric bike or the like, said assembly comprising a child carrier unit which is in the form of a hybrid child seat and stroller possible to connect to a docking unit of the assembly, said docking unit comprising two units, one first unit being an adapter arranged to be fixated to the bicycle, moped, electric bike or the like, and one second unit arranged to be fixated to or integrated into the child carrier unit,
wherein the second unit is lockable into and releasable from the first unit so that the child carrier unit is locked to and released from the bicycle, respectively,
wherein the first unit comprises a handle which is arranged to be pulled out when the child carrier unit is intended to be released from the bicycle, moped, electric bike or the like, said handle having two end positions, one first end position where the handle is in a locked state and where an interconnecting unit of the first unit is in connection to, fixating and locking the second unit, and one second end position in an open state where the handle is in a fully extended position and where the interconnecting unit is released from the second unit.

2. A child carrier and docking assembly according to claim 1, wherein the interconnecting unit is spring-loaded.

3. A child carrier and docking assembly according to claim 1, wherein the handle is spring-loaded so that the handle is self-locking when the handle is not pulled out by force.

4. A child carrier and docking assembly according to claim 1, wherein when the handle is in a locked state then the interconnecting unit is extended downwards and passes a portion of the second unit to fixate the second unit and lock the hybrid child seat and stroller and second unit to the first unit.

5. A child carrier and docking assembly according to claim 4, wherein the interconnecting unit is extended downwards and acts as a plug into the second unit to fixate the second unit and lock the hybrid child seat and stroller and second unit to the first unit when the handle is in a locked state.

6. A child carrier and docking assembly according to claim 5, wherein when the handle s pulled out then the interconnecting unit is pushed upwards to be release from the portion of the second unit to release the second unit from the first unit.

7. A child carrier and docking assembly according to claim 1, wherein the second unit arranged to be fixated to or integrated into the child carrier unit is arranged to be pulled onto and grip around the first unit being an adapter arranged to be fixated to the bicycle, moped, electric bike or the like when fixating the second unit to the first unit.

8. A child carrier and docking assembly according to claim 1, wherein the child carrier and hence second unit is arranged to be lifted outwards horizontally to be released completely from the first unit when the handle is in a fully extended position and hence open state.

9. A child carrier and docking assembly according to claim 1, wherein the interconnecting unit is angled.

10. A child carrier and docking assembly according to claim 1, wherein an open/locked indicator is connected to the first unit.

11. A child carrier and docking assembly according to claim 1, wherein a handle security lock is arranged to enable security locking and unlocking of the handle.

12. A child carrier and docking assembly according to claim 11, wherein the handle security lock is a bar arranged to be pushed, pulled or moved to unlock the handle.
